(19) United States
(12) Patent Application Publication
(10) Pub. No.: US 2013/0185180 A1
(43) Pub. Date: Jul. 18, 2013

(54) DETERMINING THE INVESTIGATION PRIORITY OF POTENTIAL SUSPICIOUS EVENTS WITHIN A FINANCIAL INSTITUTION

(71) Applicants: Carol ZHOU, Charlotte, NC (US); Cindy Kasahara-Foster, Davidson, NC (US); Subramanian Selvaraj Sulur, Charlotte, NC (US)

(72) Inventors: Carol ZHOU, Charlotte, NC (US); Cindy Kasahara-Foster, Davidson, NC (US); Subramanian Selvaraj Sulur, Charlotte, NC (US)

(73) Assignee: Bank of America Corporation, Charlotte, NC (US)

(21) Appl. No.: 13/353,137

(22) Filed: Jan. 18, 2012

(51) Int. Cl. G06Q 40/00

(52) U.S. Cl. 705/35

(57) ABSTRACT

Embodiments of the present invention relate to systems, apparatus, methods and computer program products for determining investigation prioritization for suspicious events within a financial institution. The present invention provides for continuous tuning of the risk score associated with a suspicious event or event group to insure accurate investigation prioritization based on the risk score. In addition, the present invention continuously tunes the risk score based on the sample size of cases (i.e., the confidence) used to determine the risk assessment (i.e., the effective Suspicious Activity Report (SAR) yield attributed to the event or event combination).

### FIELD

In general, embodiments of the invention relate to suspicious activity investigation and, more particularly, determining the investigation priority of suspicious events within a financial institution.

### BACKGROUND

Many events within a financial institution occur which are suspicious or potentially suspicious in terms of fraudulent, illegal or otherwise harmful activities. For example, the occurrence of certain events or combination of events may conclude that money laundering has occurred, is occurring or is about to occur. These suspicious or potentially suspicious events may be customer-related events, associate/employee-related events or third party-related events.

Currently, financial institutions implement various means of monitoring for the occurrence of events deemed to be suspicious or potential suspicious. In addition, to monitoring for the occurrence of such events, event repositories are implemented that serve to accumulate and store data related to the occurrence of the events. Such event repositories allow for related events to be grouped together, in what is referred to herein as an “event group”. An event group may include one, or typically a plurality of events related by an association between the event participants (e.g. family members, organization members or the like).

The sheer volume of suspicious or potentially suspicious events prevents the financial institution from manually investigating all of the events to determine if fraudulent, illegal or otherwise harmful activities exist. In this regard, financial institutions have attempted to determine the level of suspicious activity risk associated with suspicious events and to prioritize the investigation of such events based on the level of risk. For example, the most suspicious events or event groups (i.e., highest risk level) are investigated first while other less suspicious events or event groups (i.e., lower risk level) may be placed in queue, or in some instances, ignored until the risk level rises to an investigation threshold level. However, in many instances, the risk that is assigned to a specific suspicious event is subjective in nature and, as such, results an investigation prioritization scheme that is somewhat arbitrary and less accurate than desired.

Therefore, a need exists to develop systems, methods and the like for accurately determining investigation priority for suspicious events and/or suspicious event groups. The desired approach should effectively balance qualitative reasoning with quantitative data to result in a more accurate determination of the risk associated with an event or an event group. In terms of accuracy, the desired approach should reduce the amount of false negative investigation (i.e., failing to investigate events or events groups associated with illegal activity due to a perceived low risk) and reduce the amount of false positive investigation (i.e., investigating events or event groups determined not to be associated with illegal activity due to a perceived high risk).

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for determining investigation prioritization for suspicious events within a financial institution. The present invention provides for continuous tuning of the risk score associated with a suspicious event or event combinations to insure current accurate investigation prioritization based on the risk score. Continuous tuning, as it applies to the present invention, takes into account that new trends in suspicious activity (e.g., a new combination of activities may be deemed to be or lead to illegal/fraudulent activity) may be identified during investigation that need to be accounted for in the risk scoring of events or groups of events.

In addition, the present invention bases the risk score on the confidence of the risk assessment (i.e., the effective Suspicious Activity Report (SAR) yield attributed to the event or event combination). The confidence may be defined in terms of the number of cases used to determine the risk assessment. As such, the higher the number of cases used to determine the risk assessment, the more accurate the risk assessment and the higher the confidence. Thus, the risk score takes into account the confidence of the effective SAR yield and, thereby results in more accurate prioritization of the risk associated with the suspicious events or event combinations.

A method for risk scoring suspicious events within a financial institution to determine an investigation priority defines first embodiments of the invention. The method includes determining an effective Suspicious Activity Report (SAR) yield for each suspicious event or combination of suspicious events. The method additionally includes determining a confidence for each effective SAR yield based on a total quantity of cases associated with a corresponding effective SAR yield and determining a risk score for each suspicious event or combination of suspicious events based on the confidence of each effective SAR yield.

In specific embodiments of the method, determining the effective SAR yield further includes dividing a number of cases occurring over a predetermined time interval that include the suspicious event or combination of two suspicious events and which resulted in a SAR by a number of cases occurring over the predetermined time interval that include the suspicious event or combination of two suspicious events.

In other specific embodiments of the method, determining the effective SAR yield further comprises determining, iteratively, a highest effective SAR yield from amongst each suspicious event or combination of two suspicious events. In such embodiments, the highest effective SAR yield defines the effective SAR yield for the corresponding suspicious event or combination of two suspicious events. Once the highest effective SAR yield is determined cases included in determining the highest effective SAR yield are eliminated (i.e., removed from further consideration) in determining the next highest effective SAR yield. This process continues iteratively until all cases have been included in the determination of a highest effective SAR yield.

In still further specific embodiments of the method, determining the confidence of each effective SAR yield further includes determining a confidence interval for each effective SAR yield, wherein the confidence interval includes a lower confidence interval bound and an upper confidence interval bound. In such embodiments the method may include deriving the confidence interval from a Wilson Binomial Proportional Confidence Interval formula. In further such embodiments determining the risk score further includes determining the risk score based on the lower confidence interval bound.

Moreover, in other specific embodiments of the method, determining the risk score further comprises determining a qualitative initial risk score for each suspicious event or combinations of events based on a baseline reference event that is most likely associated with suspicious activity. In such embodiments of the method, determining the risk score may further include determining a qualitative final risk score for each combination of events based on a qualitative initial risk score of the combination of events and qualitative initial risk scores for the events comprising the combination of events.

In additional specific embodiments the method includes determining an event group risk score for the event group based on aggregating risk scores for each suspicious event or combination of suspicious events within an event group. In such embodiments the method may further include rank ordering event groups in terms of the event group risk score associated with a corresponding event group, in which the rank ordering defines a priority for promoting event groups to an investigation stage. In further related embodiments the method may include determining whether to promote the event group to an investigation stage based on the event group risk score of the event group meeting or exceeding a predetermined event group risk score threshold and/or promoting, on a random sample basis, one or more event groups to the investigation stage when the event group risk score of the event group meets or falls below the predetermined event group risk score threshold.

An apparatus for risk scoring suspicious events within a financial institution to determine the investigation priority, defines second embodiments of the invention. The apparatus includes a computing platform including at least processor and a memory in communication with the processor. The apparatus further includes a Suspicious Activity Report (SAR) yield module stored in the memory, executable by the processor and configured to determine an effective SAR yield for each suspicious event or combination of suspicious events. In addition, the apparatus includes a SAR yield confidence module stored in the memory, executable by the processor and configured to determine a confidence for each effective SAR yield based on a total quantity of cases associated with a corresponding effective SAR yield. Further, the apparatus includes a risk score module stored in the memory, executable by the processor and configured to determine a risk score for each suspicious event or combination of suspicious events based on the confidence of each effective SAR yield.

In specific embodiments of the apparatus, the SAR yield module is further configured to determine the effective SAR yield by dividing a number of cases occurring over a predetermined time interval that include the suspicious event or combination of two suspicious events and which resulted in a SAR by a number of cases occurring over the predetermined time interval that include the suspicious event or combination of two suspicious events.

In other specific embodiments of the apparatus, the SAR yield module is further configured to determine, iteratively, a highest effective SAR yield from amongst each suspicious event or combination of two suspicious events. The highest effective SAR yield defines the effective SAR yield for the corresponding suspicious event or combination of two suspicious events. In such embodiments of the apparatus, the SAR yield module is further configured to determine, iteratively, the highest effective SAR yield by eliminating, iteratively, cases from previously determined highest effective SAR yields in determining a next highest effective SAR yield.

In additional specific embodiments of the apparatus, the SAR yield confidence module is further configured to determine a confidence interval for each effective SAR yield, in which the confidence interval includes a lower confidence interval bound and an upper confidence interval bound. In related embodiments of the apparatus, the SAR yield confidence module is further configured to derive the confidence interval from a Wilson Binomial Proportional Confidence Interval formula. In other related embodiments of the apparatus, the risk score module is further configured to determine the risk score based on the lower confidence interval bound.

Moreover, in additional embodiments of the apparatus, the risk score module is further configured to determine a qualitative initial risk score for each suspicious event or combinations of events based on a baseline reference event that is most likely associated with suspicious activity. In such embodiments of the apparatus, the risk score module may be further configured to determine a qualitative final risk score for each combination of events based on a qualitative initial risk score of the combination of events and qualitative initial risk scores for the events comprising the combination of events.

In additional embodiments of the apparatus, the risk score module is further configured to determine an event group risk score for an event group based on aggregating risk scores for each suspicious event or combination of suspicious events within the event group. In related embodiments of the apparatus, the risk score module is further configured to rank order event groups in terms of the event group risk score associated with a corresponding event group, wherein the rank order defines a priority for promoting event groups to an investigation stage. In other related embodiments the apparatus includes an event group promotion module stored in the memory, executable by the processor and configured to determine whether to promote the event group to an investigation stage based on the event group risk score of the event group meeting or exceeding a predetermined event group risk score threshold and/or promote, on a random sample basis, one or more event groups to the investigation stage when the event group risk score of the event group meets or falls below the predetermined event group risk score threshold.

A computer program product including a non-transitory computer-readable medium defines third embodiments of the invention. The computer-readable medium includes computer-executable instructions configured to cause a computer to implement steps. The steps include determining an effective Suspicious Activity Report (SAR) yield for each suspicious event or combination of suspicious events. The steps additionally include determining a confidence for each effective SAR yield based on a total quantity of cases associated with a corresponding effective SAR yield. In addition, the steps include determining a risk score for each suspicious event or combination of suspicious events based on the confidence for each effective SAR yield.

Thus, further details are provided below for systems, apparatus, methods and computer program products for determining investigation prioritization for suspicious events within a financial institution. The present invention provides for continuous tuning of the risk score associated with a suspicious event or event group to insure accurate investigation prioritization based on the risk score. In addition, the present invention continuously tunes the risk score based on the sample size of cases (i.e., the confidence) used to determine the risk assessment (i.e., the effective Suspicious Activity Report (SAR) yield attributed to the event or event combination).

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Reference will now be made to the accompanying drawings, which are not necessarily drawn to scale, and wherein:

FIG. 1A is a block diagram of an apparatus configured for risk scoring suspicious events within a financial institution for the purpose of promoting event groups to the investigation/case level, in accordance with an embodiment of the present invention;

FIG. 2 is a bar graph representation of the iterative process for determining an effective SAR yield is shown, along with a corresponding effective Suspicious Activity Report (SAR) yield chart, in accordance with embodiments of the present invention;

FIG. 3A is a SAR yield confidence interval formula, in accordance with embodiments of the present invention;

FIG. 3B is an example of a portion of a SAR yield confidence interval chart, in accordance with embodiments of the present invention;

FIG. 4A is a quantitative initial risk score formula, in accordance with embodiments of the present invention;

FIG. 4B is an example of a portion of a risk score chart, including initial and final qualitative risk scores, in accordance with embodiments of the present invention;

FIG. 5 is a flow diagram of a method for risk scoring suspicious events within a financial institution for the purpose of prioritizing investigation, in accordance with an embodiment of the present invention; and

FIG. 6 is a flow diagram of a method for promoting event groups to investigation/case level based on effective SAR yields and confidence of the event within the event groups, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments of the present invention, the functions described may be implemented in hardware, software, firmware, or any combination thereof. If implemented in software, the functions may be stored or transmitted as one or more instructions or code on a computer-readable medium. Computer-readable media includes both computer storage media and communication media, including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

In general, embodiments of the present invention relate to systems, methods and computer program products for determining investigation prioritization for suspicious events that occur within a financial institution or are otherwise associated with the financial institution. The present invention provides for continuous tuning of the risk score associated with a suspicious event or event group to insure accurate investigation prioritization based on the risk score. Continuous tuning, as it applies to the present invention, takes into account that new trends in suspicious activity (e.g., a new combination of activities may be deemed to be or lead to illegal/fraudulent activity) may be identified during investigation that need to be accounted for in the risk scoring of events or groups of events.

In determining risk score, the present invention takes into account the sample of size of cases, referred to herein as the confidence of the risk assessment (i.e., the effective Suspicious Activity Report (SAR) yield attributed to the event or event combination). By accounting for the confidence of the risk assessment in determining the risk score, the present invention imparts greater accuracy in the ranking in events and/or event groups based on risk score, which in turn serves as basis for investigation prioritization.

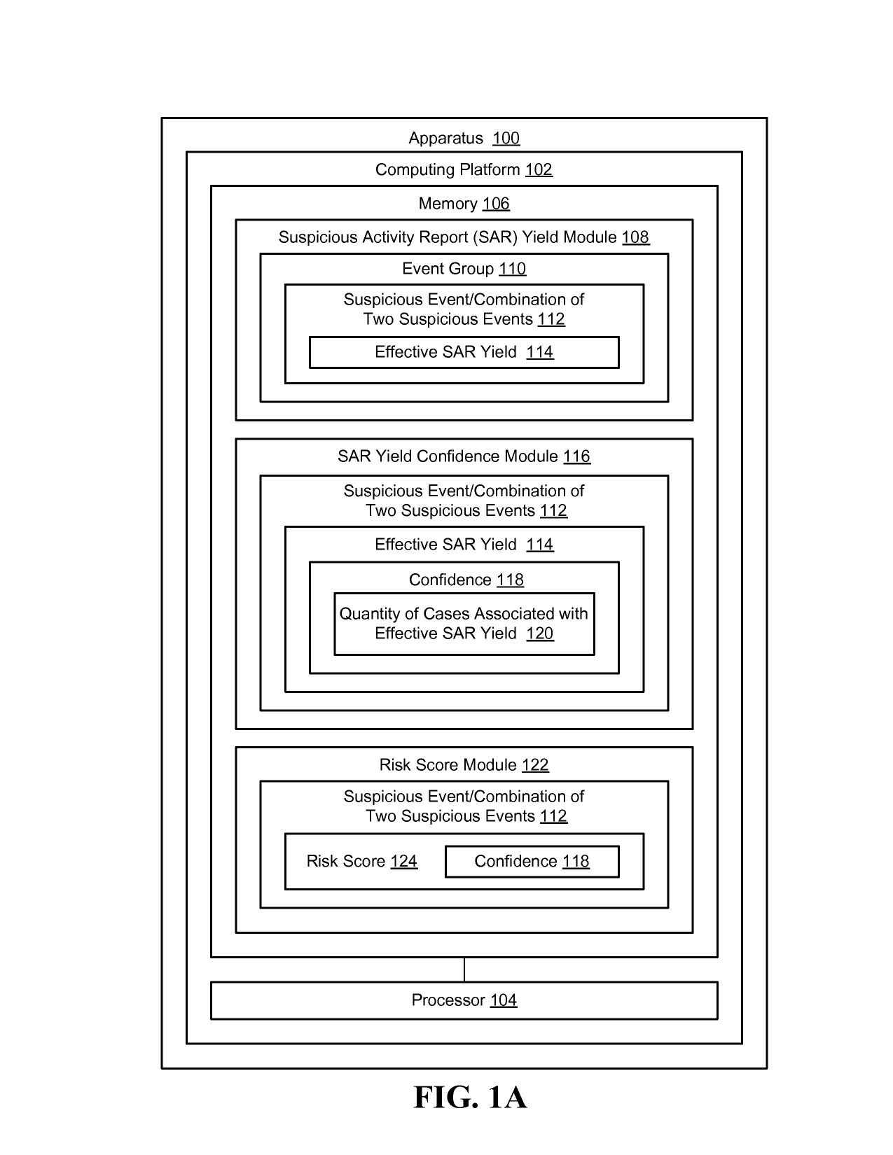

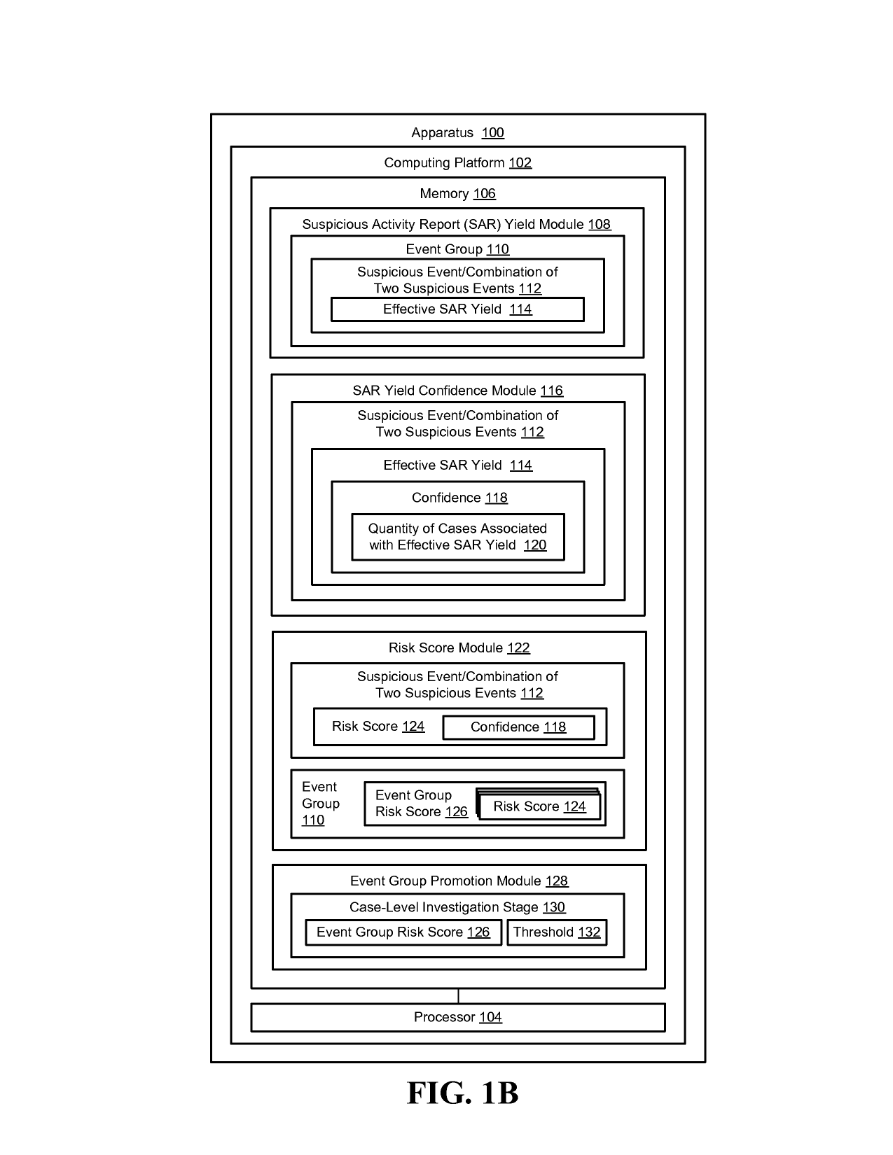

Referring to FIG. 1A a block diagram is depicted of an apparatus 100 configured to provide risk scoring of financial institution-related suspicious events for the purpose of determining investigation priority, in accordance with embodiments of the present invention. The apparatus 100 includes a computing platform 102 having a memory 106 and a processor 104 in communication with the memory. The memory 106 of apparatus 100 stores Suspicious Activity Report (SAR) yield module 108, SAR yield confidence module 116 and risk score module 122, which are implemented in combination to provide risk scoring of suspicious events for the purpose of determining case-level investigation priority.

The SAR yield module 108 is stored in the memory 106, executable by the processor 104 and configured to determine an effective SAR yield 114 for individual suspicious events and combinations of two suspicious events 112 within an event group 110. A suspicious event, otherwise referred to herein as an “event” may include one or a group of suspicious activities. The suspicious activity may by any action that requires the participant/customer to interface with the financial institution (e.g. transactions, balance inquiries, banking centers appearances, online banking logon and the like). An event group may include one, or typically a plurality of events related by an association between the event participants (e.g. family members, organization members or the like). A SAR yield is determined by comparing the number of cases occurring over a predetermined time interval that include an individual suspicious event or a combination of two suspicious events 112 and which resulted in a SAR by the number of cases occurring over the predetermined time interval that include the individual suspicious event or the combination of two suspicious events 112. A SAR, which a well-known in the art, is defined as a report that must be filed by a financial institution to the Financial Crimes Enforcement Network (FinCEN), which is an agency of the United States Department of Treasury in the event that the financial institution has determined suspicious activity or potentially suspicious activity.

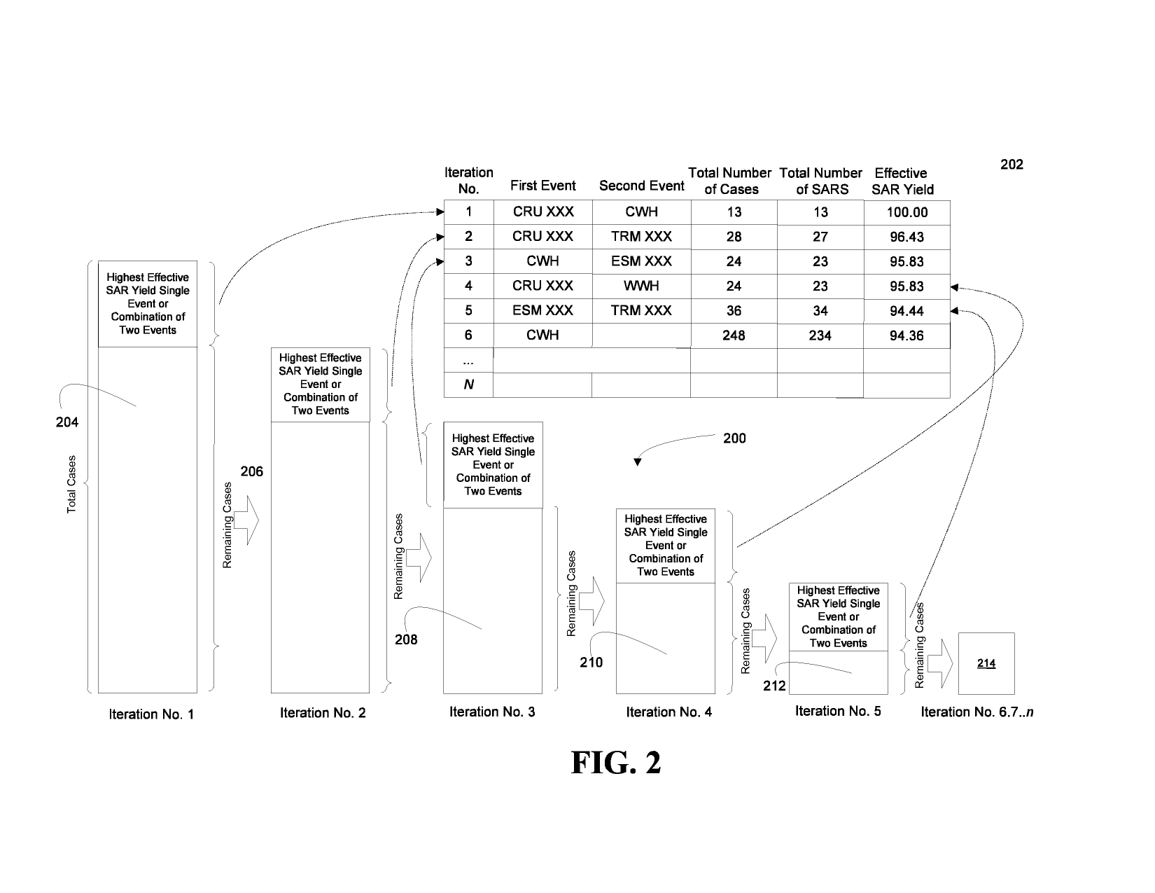

As described in more detail in relation to FIG. 2, infra, an effective SAR yield 114 is the result of an iterative process that determines the most influential single event or combination of two events associated with cases that resulted in SARs being filed. Such an iterative process eliminates the possibility of less influential individual suspicious events or combinations of suspicious events being inflated in the SAR yield determination.

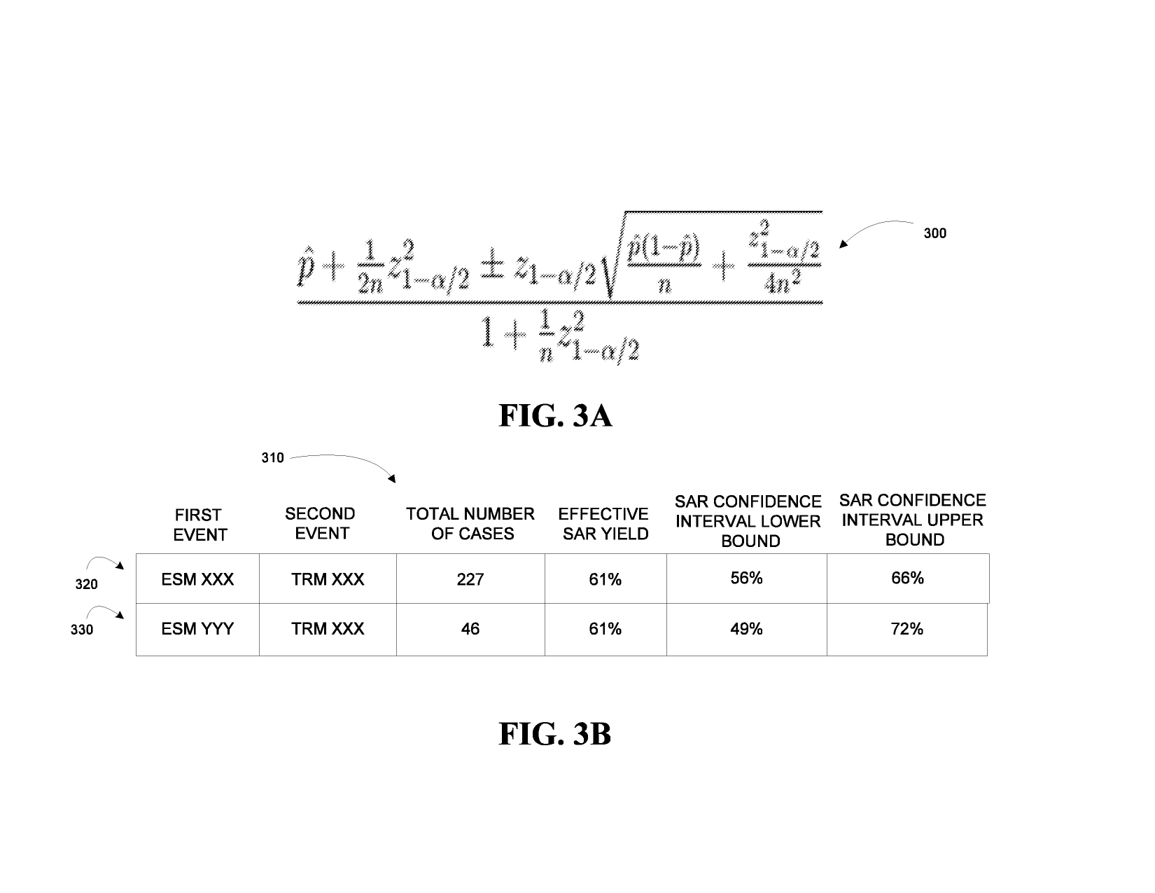

The SAR yield confidence module 116 is stored in the memory 106, executable by the processor 104 and configured to determine a confidence 118 for each effective SAR yield 114 based on the quantity of previously investigated cases 120 associated with the corresponding effective SAR yield. The confidence 118 ensures the reliability of the effective SAR yield 114 based on the sample size of cases 120 used to determine the effective SAR yield 114. For example, if the sample size of cases 120 used to determine an effective SAR yield 114 is low (e.g., less than five cases or the like) the confidence 118 for that particular effective SAR yield 114 would be low and if the sample of cases 120 used to determine an effective SAR yield 114 is high the confidence 118 for that particular effective SAR yield 114 would be high. In specific embodiments of the invention, the confidence 18 is a confidence interval, having a low bound and an upper bound, in which the narrower the interval the higher the confidence in the effective SAR yield. Further discussion related to confidence is described infra. in relation to FIG. 3.

The risk score module 122 is stored in the memory 106, executable by the processor 104 and configured to determine a risk score 124 for each of the individual suspicious events and combinations of events 112 based of the confidence 118 of the associated effective SAR yield 114.

FIG. 1B is block diagram configured to provide investigation priority of event groups, in accordance with alternate embodiments of the invention. The apparatus 100 includes a memory 106 that stores SAR yield module 108, SAR yield confidence module 116, risk score module 122 and event group promotion module 128. The risk score module 122 shown and described in relation to FIG. 1A, is further configured to determine an event group risk score 126 for the event group 110 based on aggregating risk scores 124 for the suspicious events and combinations of suspicious events included in the event group 110.

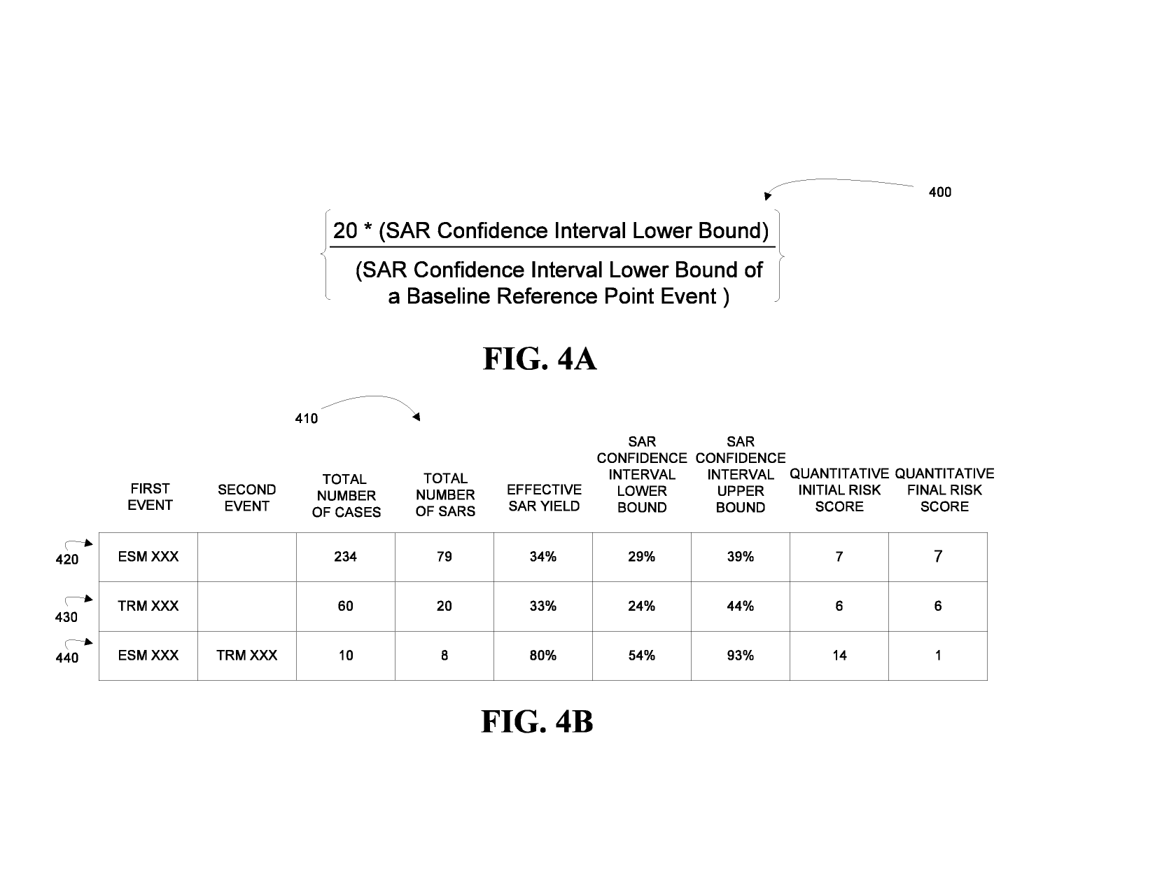

The event group promotion module 128 is stored in the memory 106, executable by the processor 104 and configured to determine whether to promote an event group to the case-level investigation stage 130 based on the event group risk score 126 meeting or exceeding a predetermined case promotion threshold 132. Promotion of event groups to the case-level or investigation stage involves manual intervention to assess whether the suspicious events rise to the level of suspicious activity or potential suspicious activity and, therefore, require the filing of a SAR. In alternate embodiments of the invention, the event group promotion module 128 is further configured to randomly promote event groups 110 that meet or fall below the predetermined case promotion threshold 134. Such random promotion of event groups 110 allows for evaluation of the risk associated with such event groups 110 in that, event groups 110 that fail to meet or exceed the case promotion threshold 134 would otherwise fail to be investigated even though they may be associated with illegal activity due to the perceived low risk (i.e., the low event group risk score 126). Further discussion related to risk scoring and case-level instigation promotion is described infra. in relation to FIG. 4.

Referring to FIG. 2 a schematic bar graph representation 200 of the iterative process for determining an effective SAR yield is shown, along with a corresponding effective SAR yield chart 202, in accordance with embodiments of the present invention. The iterative process eliminates the possibility of less influential events of combinations of events being inflated in the SAR yield calculation. The effective SAR yield process herein described is based on the assumption that a case decision (i.e., SAR filed vs. no SAR filed) is sufficiently explained by one suspicious event or a combination of two suspicious events.

Bar 204 represents the first iteration of the process in which all of the investigated cases occurring during the predetermined time interval (e.g., previous three months) are considered in determining either (1) an individual suspicious event or (2) a combination of two suspicious events having the highest effective SAR yield. In the illustrated SAR yield chart 202, Iteration No. 1 results in a highest effective SAR yield of 100.00 based on thirteen (13) cases having the two suspicious events shown (CRU XXX and CWH) and all thirteen (13) of those cases resulting in SARs.

Bar 206 represents the second iteration of the process in which the investigated cases associated with the previous highest effective SAR yield are removed from consideration in determining either (1) an individual suspicious event or (2) a combination of two suspicious events having the next highest effective SAR yield. Thus, in the example shown in FIG. 2 the thirteen (13) cases (associated with the highest effective SAR yield determined in the first iteration) are removed from consideration for the second iteration. In the illustrated SAR yield chart 202, Iteration No. 2 results in a highest effective SAR yield of 96.43 based on twenty-eight (28) cases having the two suspicious events shown (CRU XXX and TRW XXX) and twenty-seven (27) of those cases resulting in SARs.

Bar 208 represents the third iteration of the process in which the investigated cases associated with the previous highest effective SAR yields are removed from consideration in determining either (1) an individual suspicious event or (2) a combination of two suspicious events having the next highest effective SAR yield. Thus, in the example shown in FIG. 2 the forty-one (41) cases (associated with the highest effective SAR yields determined in the first and second iterations) have been removed from consideration for the third iteration. In the illustrated SAR yield chart 202, Iteration No. 3 results in a highest effective SAR yield of 95.83 based on twenty-four (24) cases having the two suspicious events shown (CWH XXX and ESM XXX) and twenty-three (23) of those cases resulting in SARs.

Bar 210 represents the fourth iteration of the process in which the investigated cases associated with the previous highest effective SAR yields are removed from consideration in determining either (1) an individual suspicious event or (2) a combination of two suspicious events having the next highest effective SAR yield. Thus, in the example shown in FIG. 2 the sixty-five (65) cases (associated with the highest effective SAR yields determined in the first, second and third iterations) have been removed from consideration for the fourth iteration. In the illustrated SAR yield chart 202, Iteration No. 4 results in a highest effective SAR yield of 95.83 based on twenty-four (24) cases having the two suspicious events shown (CRU XXX and WWH and twenty-three (23) of those cases resulting in SARs.

Bar 212 represents the fifth iteration of the process in which the investigated cases associated with the previous highest effective SAR yields are removed from consideration in determining either (1) an individual suspicious event or (2) a combination of two suspicious events having the next highest effective SAR yield. Thus, in the example shown in FIG. 2 the eighty-nine (89) cases (associated with the highest effective SAR yields determined in the first, second, third and fourth iterations) have been removed from consideration for the fifth iteration. In the illustrated SAR yield chart 202, Iteration No. 5 results in a highest effective SAR yield of 94.44 based on thirty-six (36) cases having the two suspicious events shown (ESM XXX and TRM XXX) and thirty-four (34) of those cases resulting in SARs.

Block 214 represents further iterations of the process. The iterative process continues until all of the investigated cases have been accounted for (i.e., no further investigated cased to consider).

The SAR yield chart 202 additionally includes entries for the sixth iteration and provides for entries to be made up through the Nth iteration (i.e., the last iteration). Of note, the sixth iteration has determined that the next highest SAR yield rate has only one individual suspicious event (CWH) as opposed to a combination of two suspicious events, such as exhibited by the previous five iterations. Referring to FIGS. 3A and 3B shown is a confidence interval formula 300 for determining an effective SAR yield confidence interval and an effective SAR yield confidence interval chart 310, respectively, in accordance with embodiments of the present invention. According to embodiments of the present invention, a confidence is determined for each effective SAR yield. The confidence is based on the quantity of previous cases associated with a corresponding effective SAR yield. Thus, confidence determination is implemented to ensure the reliability (i.e., confidence) that the sample of cases used to determine the effective SAR yield is representative of the total population of cases. In specific embodiments of the invention, the confidence is defined as a confidence interval having a lower bound and an upper bound. The lower bound is representative of the minimum of the confidence interval and the upper bound is representative of the maximum of the confidence interval. In specific embodiments of the invention, the SAR yield confidence interval is derived from Wilson's Binomial Proportion Confidence Interval formula. Shown in FIG. 3A as confidence interval formula 300. In the confidence interval formula 300, \hat{p} is the effective SAR yield, z is the confidence, n is the sample size, and α is the error.

FIG. 3B depicts an exemplary portion of an effective SAR yield confidence interval chart 310. In the illustrated example only two entries are shown in the chart 310 for the sake of brevity. The reader should note that in practice a completed chart 310 would include confidence intervals for all of the events or combination of two events that resulted in an effective SAR yield. In the illustrated effective SAR yield confidence interval chart 310, the first confidence interval entry 320, includes First Event ESM XXX and Second Event TRM XXX, which resulted in an effective SAR yield of 61.00 based on based on two-hundred and twenty-seven (227) cases having the two suspicious events shown (ESM XXX and TRM XXX) and one-hundred and thirty-seven (137) of those cases resulting in SARs (not shown in chart 310). Based on the total number of cases (227) having the two suspicious events and an effective SAR yield of 61%, the resulting SAR confidence interval lower bound is 56% and the SAR confidence interval upper bound is 66%. Further, the second confidence interval entry 330 includes First Event ESM YYY and Second Event TRM XXX resulted in an effective SAR yield of 61.00 based on based on forty-six (46) cases having the two suspicious events shown (ESM YYY and TRM XXX) and twenty-eight (28) of those cases resulting in SARs (not shown in chart 310). Based on the total number of cases (46) having the two suspicious events and an effective SAR yield of 61%, the resulting SAR confidence interval lower bound is 49% and the SAR confidence interval upper bound is 72%.

It should be noted that the smaller the interval, the greater the overall confidence or reliability in the effective SAR yield. As such, while the first and second confidence interval entries 320 and 330 both had the same or similar effective SAR yields (i.e., 61%), the interval for the first confidence interval entry 320 is 6 percentage points (66-56), while the interval for the second confidence interval entry 330 is 23 percentage points (72-49). The disparity in the confidence intervals being due to the fact the first entry effective SAR yield was based on a much larger total number of cases (227) that the second entry effective SAR yield (46 cases). In considering a confidence interval basis for risk scoring of the events or combination of events, it is noted that the upper bound has a tendency to over inflate false positives while the lower bound minimizes false positives in instances of greater variability and in SAR effective yields based on a larger number of cases. This is because in such instances, in which the SAR effective yield is based on a larger number of cases, the confidence interval is smaller such that the difference between the lower bound, the effective SAR yield and the upper bound is minimal.

Referring to FIGS. 4A and 4B shown is a qualitative initial risk score formula 400 for determining a qualitative initial risk score and a risk score chart 410, respectively, in accordance with embodiments of the present invention. In specific embodiments of the invention, a risk score is determined for each suspicious event or the combinations of suspicious events that resulted in an effective SAR yield based on the determined confidence. In further specific embodiments of the invention, the risk score is based on the SAR confidence interval lower bound. As previously noted, the lower bound minimizes false positives and prevents unnecessary bias in the value of the risk score, thereby assuring that event groups having more suspicious activities are more readily promoted to case level for investigation, while allow for more time for event groups with less suspicious activities to conceivably mature to a risk level which would require promotion to the case level.

In the exemplary qualitative initial risk score formula 400 shown in FIG. 4A, the SAR confidence interval lower bound is converted to risk score on a predetermined scale. In the illustrated example the qualitative initial risk score is based on a predetermined scale of zero (0) to twenty (20). The denominator of the formula, reflects the SAR confidence interval lower bound of a baseline reference point for the most likely event or combination of two events resulting in potentially suspicious activity (i.e., the event or combination of events having the highest effective SAR yield). Thus, in the qualitative risk score formula 400, since the baseline reference point event or combination of two events would have a risk score of 20, which reflects the highest possible risk for a SAR being issued, in other words, that specific event appearing in a case invariably results in a SAR being issued.

FIG. 4B depicts an exemplary portion of a risk score chart 410. In the illustrated example only three entries are shown in the chart 410 for the sake of brevity. The reader should note that in practice a completed chart 410 would include risk scores for all of the events or combination of two events that resulted in an effective SAR yield. The risk score chart 410 includes entries for the qualitative initial risk score, calculated using the formula shown in FIG. 4A and a qualitative final risk score. The qualitative final risk score takes into account that a qualitative initial risk score for a combination of two events may include individual risk score components for at least one and some instances both events, if the individual event resulted in an effective SAR yield. Thus, for initial risk scores based on a combination of two events the quantitative final risk score is calculated by subtracting the initial risk scores for one or both events from the initial risk score of the combination of two events.

In the illustrated risk score chart 410, the first risk score entry 420 includes First Event ESM XXX, which resulted in an effective SAR yield of 34% based on based on two-hundred and thirty-four (234) cases having the ESM XXX event and seventy-nine (79) of those cases resulting in SARs. Implementing the confidence interval formula shown in FIG. 3A, the resulting SAR confidence interval lower bound is 29% and the SAR confidence interval upper bound is 39%. Implementing the risk score formula shown in FIG. 4A, which is based on the lower bound (29%), the resulting quantitative initial risk score is 7(20*(0.29)/0.77=7). Since the effective SAR yield is based on the occurrence of a single event, the quantitative final risk score is equal to the quantitative initial risk score (7).

The second risk score entry 430 includes First Event TRM XXX, which resulted in an effective SAR yield of 33% based on based on sixty (60) cases having the TRM XXX event and twenty (20) of those cases resulting in SARs. Implementing the confidence interval formula shown in FIG. 3A, the resulting SAR confidence interval lower bound is 24% and the SAR confidence interval upper bound is 44%. Implementing the risk score formula shown in FIG. 4A, which is based on the lower bound (24%), the resulting quantitative initial risk score is 6(20*(0.24)/0.77=6). Similar to the first risk score entry 420, since the effective SAR yield is based on the occurrence of a single event, the quantitative final risk score is equal to the quantitative initial risk score (6).

The third risk score entry 440 includes First Event ESM XXX and Second Event TRM XXX, which resulted in an effective SAR yield of 80% based on based on ten (10) cases having the ESM XXX and TRM XXX events and eight (8) of those cases resulting in SARs. Implementing the confidence interval formula shown in FIG. 3A, the resulting SAR confidence interval lower bound is 54% and the SAR confidence interval upper bound is 93%. Implementing the risk score formula shown in FIG. 4A, which is based on the lower bound (54%), the resulting quantitative initial risk score is 14(20*(0.54)/0.77=14). Since the effective SAR yield is based on the occurrence of two events event, the quantitative final risk score is equal to the quantitative initial risk score (14) offset by the quantitative initial risk scores for the individual events (7 for ESM XXX and 6 for TRM XXX), resulting in a quantitative final risk score of 1(14−(7+6)).

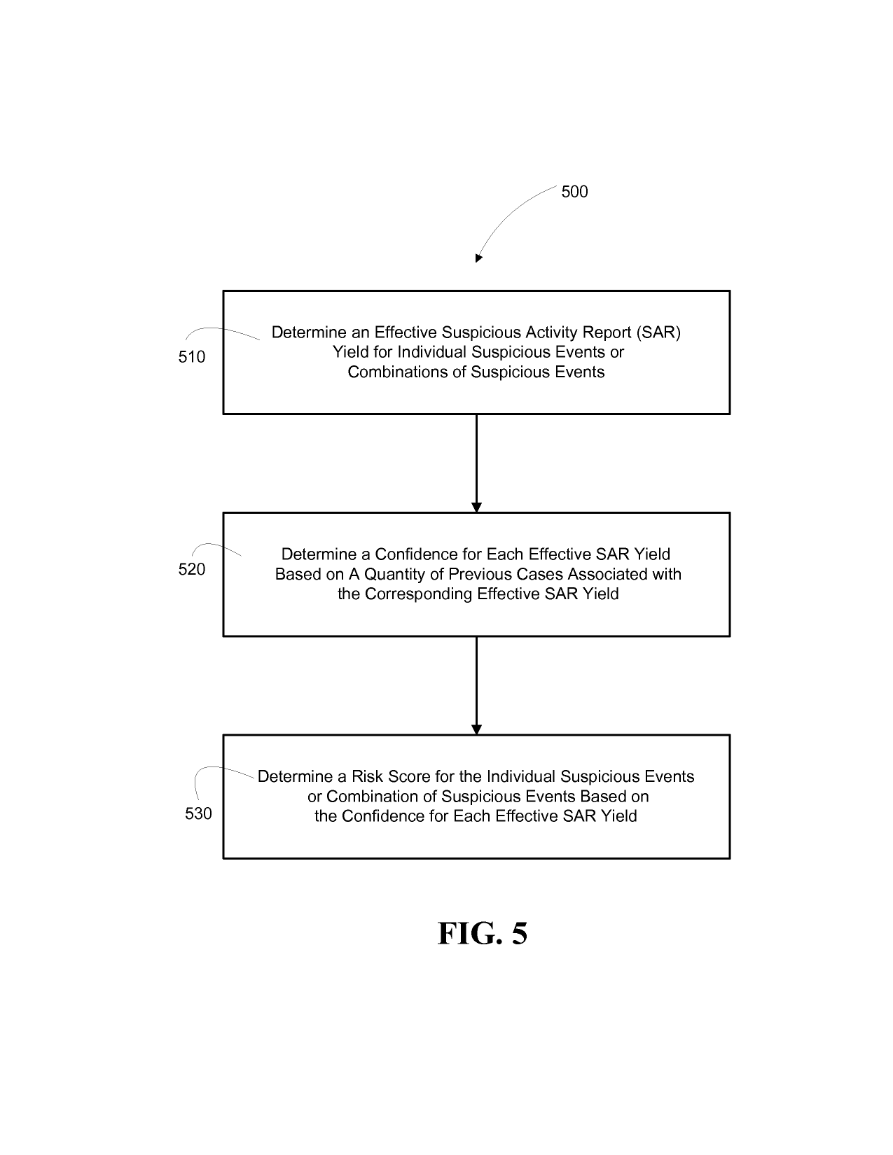

Turning the reader's attention to FIG. 5, a flow diagram is presented of a method 500 for risk scoring suspicious events that occur within a financial institution for the purpose of determining an investigation priority, in accordance with embodiments of the present invention. At Event 510, an effective Suspicious Activity Report (SAR) yield is determined for a suspicious event or a combination of events, such as, a combination of two events. As previously noted a SAR is a report that must be filed with the United States government in the event that a financial institution determines that suspicious activity has or likely has occurred. The financial institution determines that suspicious activity has or likely has occurred by manually investigating what is referred to as “case”. The case comprises an event group, which includes one or more related events. The financial institution provides the capability to monitor for the occurrence of the events (e.g., wire transfers above a designated amount, wire transfers to designated countries and the like) and to group events based predetermined associations (e.g., events associated with customers who are related or the like).

Thus, a SAR yield is a measure of the number of cases that have been investigated over a predetermined time period (e.g., the previous three, or six months or the like) that includes a specified event or a combination of two events in comparison to the number of those cases that resulted in SAR filing. An effective SAR yield is provided by an iterative process whereby the highest SAR yield is determined for either a single event or a combination of two events. Once the highest SAR yield is determined, the cases associated with the highest SAR yield are removed from further consideration and the next highest SAR yield is determined. Subsequent highest SAR yields are determined until all of the cases that have been investigated over the predetermined time have been removed from further consideration. An example of an effective SAR yield process is shown and described in relation to FIG. 2.

At Event 520, a confidence is determined for each effective SAR yield based on the quantity of previous cases associated with the corresponding effective SAR yield. The confidence, which may otherwise be referred to as a confidence weighting or reliability weighting, takes into account that an effective SAR yield is more accurate if the sample size if cases using in determining the effective SAR yield is larger. For example, an effective SAR yield based on two-hundred and fifty cases (250) cases is more accurate than an effective SAR yield based on ten (10) cases. In this regard, the confidence quantifies the accuracy of the effective SAR yield. In specific embodiments, the confidence is a SAR yield confidence interval that is derived from Wilson's Binomial Proportion Confidence Interval formula. The interval includes a lower bound and an upper bound, in which the size of the interval (i.e., the distance between the lower and upper bounds) reflects the accuracy of the effective SAR yield (i.e., the smaller the interval the greater the accuracy).

At Event 530, a risk score is determined for the individual suspicious events or the combination of suspicious events (e.g., a combination of two suspicious events) that resulted in effective SAR yields based on the determined confidence of each effective SAR yield. The risk scores of the event or combination of events may subsequently be used to provide for an event group risk score. An event group risk score is an aggregation of the individual risk scores associated with the events or combination of events that comprise the event group. In specific embodiments of the invention, event groups having an event group risk score at or above a predetermined threshold will be promoted to the “case” level for subsequent investigation. In other specific embodiments of the invention, event groups having an event group risk score at or below the predetermined threshold will be randomly sampled for promotion to the “case” level to insure that the SAR yield means of promoting cases is not under inclusive.

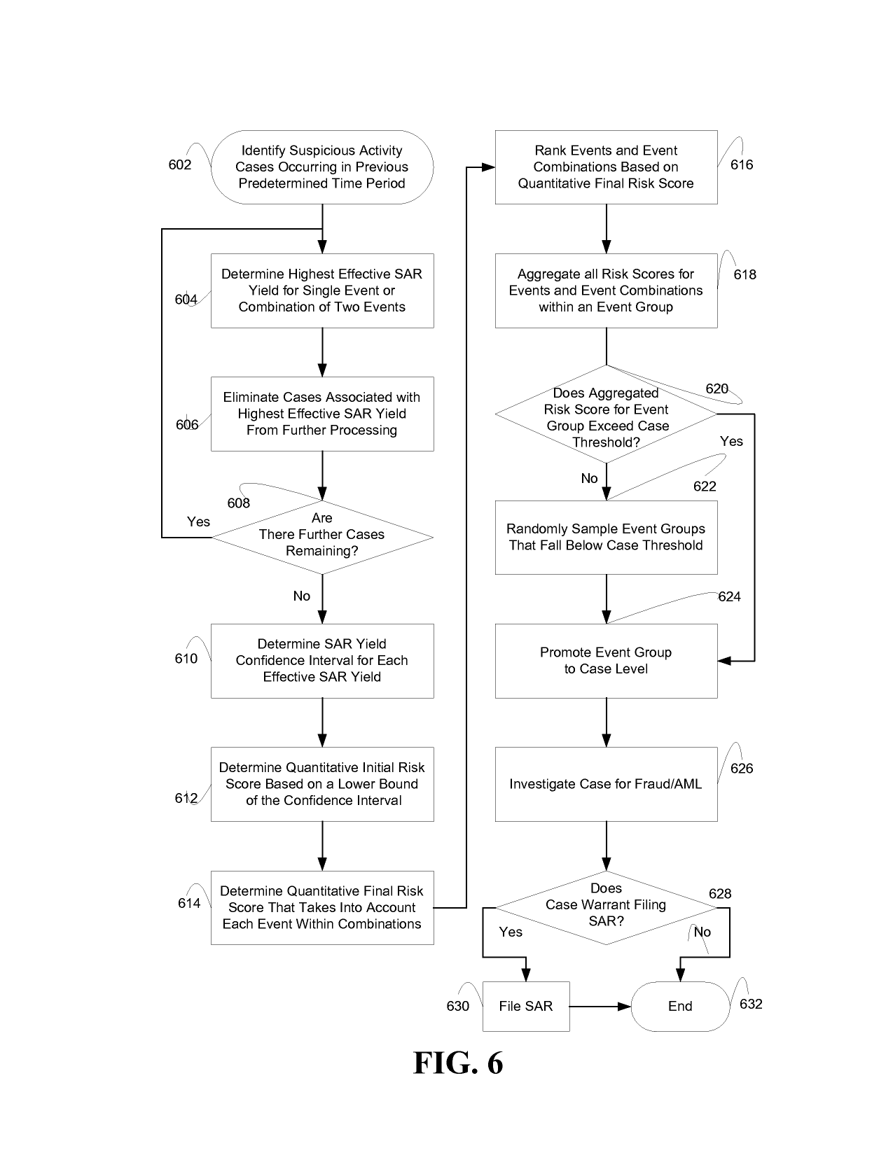

Referring to FIG. 6 an additional flow diagram is presented of a method 600 for risk scoring suspicious events that occur within a financial institution, determining an investigation priority based on the risk score and investigating cases, in accordance with embodiments of the present invention. At Event 602, the process is initiated by identifying suspicious activity cases investigated occurring within a predetermined time period, for example the previous three, six, twelve months or the like. The identified investigated cases form the basis for subsequent effective SAR yield determinations.

At Event 604, a highest effective SAR yield is determined for either an event or a combination of events occurring within the investigated cases. As previous noted, the highest effective SAR yield is the highest percentage of the number of cases that have been investigated during a predetermined time period (e.g., the previous three, or six months or the like) that include a specified event or a combination of two events and that resulted in a SAR filing in comparison to the overall number of cases that have been investigated during the time period and include the specified event or the combination of two events. Once the highest effective SAR yield has been determined, at Event 606 cases associated with the highest SAR yield are removed or eliminated from further consideration (i.e., further determination of subsequent next highest effective SAR yields).

At Decision 608, a determination is made as to whether further cases remain for determining next highest effective SAR yield. If the determination is made that further cases remain, the iterative process continues by returning to Event 604 where the next highest effective SAR yield is determined for a single event or a combination of two events. If the determination is made that no further cases remain (i.e., all of the cases are associated with an effective SAR yield), at Event 610, a SAR yield confidence interval is determined for each effective SAR yield. As previously noted, in specific embodiments of the invention, the confidence interval is derived from a binomial proportion confidence interval formula, such as Wilson score interval or the like. The confidence interval ensure reliability that the sample of cases used to determine an effective SAR yield is properly weighted to represent the overall population of cases used to determine each effective SAR yield.

At Event 612, a qualitative initial risk score is determined for each event and combination of two events that formed the basis for an effective SAR yield. The qualitative initial risk score is based on the lower bound of the confidence interval. In specific embodiments, the lower bound of the confidence interval is used to render a risk score so as to minimize false positives when there is greater variability in the interval. In specific embodiments the risk score is scaled using a predetermined event that is most likely to result in a SAR as the baseline reference point. In such embodiments, the lower bound of the confidence interval of the predetermined event is used to rescale the lower bound confidence interval of the effective SAR yield. At Event 614, qualitative final risk scores are determined for combinations of two events. The qualitative final risk score takes into account each event within the combination by offsetting the initial risk score of the combined event by the risk score(s) of the individual events within the combination.

At Event 616, the events and/or event combinations are rank ordered based on their respect quantitative final risk score. Ranking ordering of the events and event combinations allows for management to better assess the impact of risk score changes, the need to add or eliminate event combinations, trends in risk scoring and the like.

At Event 619, all of the risk scores for events and event groups that exist within an event group are aggregated resulting in a cumulative event group risk score. At Decision 620, a determination is made as to whether the aggregated/cumulative event group risk score meets or exceeds a case promotion threshold. If the cumulative event group risk score meets or exceeds the case promotion threshold, at Event 624, the event group is promoted to the case level. If the cumulative event group risk score does not meet or exceed the case promotion threshold, at Event 622, the event groups are randomly sampled throughout the subsequent investigation period and, at Event 624, the randomly sampled event groups are promoted to the case level.

At Event 626, the cases are investigated for suspicious activity, for example actual or suspected Anti-Money Laundering (AML) activity, such as fraudulent activity or the like. At Decision 628, a determination is made as to whether the investigation of the case warrants the filing of a Suspicious Activity Report (SAR) with the United States government. If the investigation of the case has determined that the filing of SAR is warranted, at Event 630, a SAR is generated and filed with the appropriate United States government agency. If the investigation of the case has determined that the filing of a SAR is not warranted, at Event 632, the process ends.

Thus, present embodiments disclosed in detail above provide for systems, apparatus, methods and computer program products for determining investigation prioritization for suspicious events within a financial institution. The present invention provides for continuous tuning of the risk score associated with a suspicious event or event group to insure accurate investigation prioritization based on the risk score. In addition, the present invention continuously tunes the risk score based on the sample size of cases (i.e., the confidence) used to determine the risk assessment (i.e., the effective Suspicious Activity Report (SAR) yield attributed to the event or event combination).

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for risk scoring suspicious events within a financial institution to determine an investigation priority, the method comprising:
determining, via a computing device processor, an effective Suspicious Activity Report (SAR) yield for individual suspicious events or combinations of suspicious events;
determining, via a computing device processor, a confidence for each effective SAR yield based on a quantity of previous cases associated with a corresponding effective SAR yield; and
determining, via a computing device processor, a risk score for the individual suspicious events or the combinations of suspicious events based on the confidence for each effective SAR yield.

2. The method of claim 1, wherein determining the effective SAR yield further comprises dividing a number of cases occurring over a predetermined time interval that include the individual suspicious event or a combination of two suspicious events and which resulted in a SAR by a number of cases occurring over the predetermined time interval that include the individual suspicious event or the combination of two suspicious events.

3. The method of claim 1, wherein determining the effective SAR yield further comprises determining, iteratively, a highest effective SAR yield from amongst the individual suspicious events or a combination of two suspicious events, wherein the highest effective SAR yield defines the effective SAR yield for the corresponding suspicious event or combination of two suspicious events.

4. The method of claim 3, wherein determining, iteratively, the highest effective SAR yield further comprises eliminating, iteratively, cases from previously determined highest effective SAR yields in determining a next highest effective SAR yield.

5. The method of claim 1, wherein determining the confidence further comprises determining a confidence interval for each effective SAR yield, wherein the confidence interval includes a lower confidence interval bound and an upper confidence interval bound.

6. The method of claim 5, wherein determining the confidence interval further comprises deriving the confidence interval from a Wilson Binomial Proportional Confidence Interval formula.

7. The method of claim 5, wherein determining the risk score further comprises determining the risk score based on the lower confidence interval bound.

8. The method of claim 1, wherein determining the risk score further comprises determining a qualitative initial risk score for the individual suspicious events or the combinations of suspicious events based on a baseline reference event that is most likely associated with suspicious activity.

9. The method of claim 1, wherein determining the risk score further comprises determining a qualitative final risk score for each of the combinations of suspicious events based on a qualitative initial risk score of the combinations of events and qualitative initial risk scores for suspicious events comprising the combination of events.

10. The method of claim 1, further comprising determining, via a computing device processor, an event group risk score for an event group based on aggregating risk scores for the individual suspicious events or the combinations of suspicious events within the event group.

11. The method of claim 10, further comprising rank ordering event groups in terms of the event group risk score associated with a corresponding event group, wherein the rank ordering defines a priority for promoting event groups to a case-level investigation stage.

12. The method of claim 10, further comprising determining, via a computing device processor, whether to promote the event group to a case-level investigation stage based on the event group risk score of the event group meeting or exceeding a predetermined event group risk score threshold.

13. The method of claim 12, further comprising promoting, on a random sample basis, one or more event groups to the case-level investigation stage when the event group risk score of the event group meets or falls below the predetermined event group risk score threshold.

14. An apparatus for risk scoring suspicious events within a financial institution to determine the investigation priority, the method comprising:
a computing platform including at least processor and a memory in communication with the processor;
a Suspicious Activity Report (SAR) yield module stored in the memory, executable by the processor and configured to determine an effective SAR yield for individual suspicious events or combinations of suspicious events;
a SAR yield confidence module stored in the memory, executable by the processor and configured to determine a confidence for each effective SAR yield based on a quantity of previous cases associated with a corresponding effective SAR yield; and
a risk score module stored in the memory, executable by the processor and configured to determine a risk score for the individual suspicious events or the combinations of suspicious events based on the confidence for each effective SAR yield.

15. The apparatus of claim 14, wherein the SAR yield module is further configured to determine the effective SAR yield by dividing a number of cases occurring over a predetermined time interval that include the individual suspicious events or a combination of two suspicious events and which resulted in a SAR by a number of cases occurring over the predetermined time interval that include the individual suspicious event or the combination of two suspicious events.

16. The apparatus of claim 14, wherein the SAR yield module is further configured to determine, iteratively, a highest effective SAR yield from amongst the individual suspicious events or a combination of two suspicious events, wherein the highest effective SAR yield defines the effective SAR yield for the corresponding individual suspicious event or the combination of two suspicious events.

17. The apparatus of claim 16, wherein the SAR yield module is further configured to determine, iteratively, the highest effective SAR yield by eliminating, iteratively, cases from previously determined highest effective SAR yields in determining a next highest effective SAR yield.

18. The apparatus of claim 14, wherein the SAR yield confidence module is further configured to determine a confidence interval for each effective SAR yield, wherein the confidence interval includes a lower confidence interval bound and an upper confidence interval bound.

19. The apparatus of claim 18, wherein the SAR yield confidence module is further configured to derive the confidence interval from a Wilson Binomial Proportional Confidence Interval formula.

20. The apparatus of claim 18, wherein the risk score module is further configured to determine the risk score based on the lower confidence interval bound.

21. The apparatus of claim 14, wherein the risk score module is further configured to determine a qualitative initial risk score for the individual suspicious events or the combinations of suspicious events based on a baseline reference event that is most likely associated with suspicious activity.

22. The apparatus of claim 21, wherein the risk score module is further configured to determine a qualitative final risk score for each of the combinations of suspicious events based on a qualitative initial risk score of the combination of suspicious events and qualitative initial risk scores for the events comprising the combination of events.

23. The apparatus of claim 14, wherein the risk score module is further configured to determine an event group risk score for an event group based on aggregating risk scores for individual suspicious events or combinations of suspicious events within the event group.

24. The apparatus of claim 23, wherein the risk score module is further configured to rank order event groups in terms of the event group risk score associated with a corresponding event group, wherein the rank order defines a priority for promoting event groups to a case-level investigation stage.

25. The apparatus of claim 23, further comprising an event group promotion module stored in the memory, executable by the processor and configured to determine whether to promote the event group to a case-level investigation stage based on the event group risk score of the event group meeting or exceeding a predetermined event group risk score threshold.

26. The apparatus of claim 25, wherein the event group promotion module is further configured to promote, on a random sample basis, one or more event groups to the case-level investigation stage when the event group risk score of the event group meets or falls below the predetermined event group risk score threshold.

27. A computer program product, the computer program product comprising a non-transitory computer-readable medium having computer-executable instructions to cause a computer to implement the steps of:
determining an effective Suspicious Activity Report (SAR) yield for individual suspicious events or combinations of suspicious events;
determining a confidence for each effective SAR yield based on a quantity of previous cases associated with a corresponding effective SAR yield;
determining a risk score for the individual suspicious events or the combinations of suspicious events based on the confidence of each effective SAR yield.

28. The computer program product of claim 27, wherein the computer-executable instructions cause the computer to implement the step of determining the effective SAR yield by dividing a number of cases occurring over a predetermined time interval that include the individual suspicious event or a combination of two suspicious events and which resulted in a SAR by a number of cases occurring over the predetermined time interval that include the individual suspicious event or the combination of two suspicious events.

29. The computer program product of claim 27, wherein the computer-executable instructions cause the computer to implement the step of determining, iteratively, a highest effective SAR yield from amongst the individual suspicious events or a combination of two suspicious events, wherein the highest effective SAR yield defines the effective SAR yield for the corresponding individual suspicious event or the combination of two suspicious events.

30. The computer program product of claim 29, wherein the computer-executable instructions cause the computer to implement the step of determining, iteratively, the highest effective SAR yield by eliminating, iteratively, cases from previously determined highest effective SAR yields in determining a next highest effective SAR yield.

31. The computer program product of claim 27, wherein the computer-executable instructions cause the computer to implement the step of determining a confidence interval for each effective SAR yield, wherein the confidence interval includes a lower confidence interval bound and an upper confidence interval bound.

32. The computer program product of claim 31, wherein the computer-executable instructions cause the computer to implement the step of deriving the confidence interval from a Wilson Binomial Proportional Confidence Interval formula.

33. The computer program product of claim 31, wherein the computer-executable instructions cause the computer to implement the step of determining the risk score based on the lower confidence interval bound.

34. The computer program product of claim 27, wherein the computer-executable instructions cause the computer to implement the step of determining a qualitative initial risk score for the individual suspicious events or the combinations of suspicious events based on a baseline reference event that is most likely associated with suspicious activity.

35. The computer program product of claim 34, wherein the computer-executable instructions cause the computer to implement the step of determining a qualitative final risk score for the combinations of suspicious events based on a qualitative initial risk score of the combination of events and qualitative initial risk scores for individual suspicious events comprising the combination of suspicious events.

36. The computer program product of claim 27, wherein the computer-executable instructions cause the computer to implement the step of determining an event group risk score for the event group based on aggregating risk scores for the individual suspicious events or the combinations of suspicious events within an event group.

37. The computer program product of claim 36, wherein the computer-executable instructions cause the computer to implement the step of rank ordering event groups in terms of the event group risk score associated with a corresponding event group, wherein the rank ordering defines a priority for promoting event groups to a case-level investigation stage.

38. The computer program product of claim 36, wherein the computer-executable instructions cause the computer to implement the step of determine whether to promote the event group to a case-level investigation stage based on the event group risk score of the event group meeting or exceeding a predetermined event group risk score threshold.

39. The computer program product of claim 38, wherein the computer-executable instructions cause the computer to implement the step of promoting, on a random sample basis, one or more event groups to the case-level investigation stage when the event group risk score of the event group meets or falls below the predetermined event group risk score threshold.
